(19) United States
(12) Patent Application Publication
(10) Pub. No.: US 2007/0050612 A1
(43) Pub. Date: Mar. 1, 2007

(54) Boot program update and restoration system and method thereof

(75) Inventor: Chih-Wei Chen, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/211,733

(22) Filed: Aug. 26, 2005

(51) Int. Cl. G06F 1/24

(52) U.S. Cl. 713/100

(57) ABSTRACT

A boot program update and restoration system and method, which checks a flag value to determine the status of the boot program when a computer-based platform updates the boot program. Besides, when the computer-based platform executes the BIOS, the system and method further checks the status of the boot program and restores the boot program when it is corrupted.

### BACKGROUND OF THE INVENTION

1. Field of Invention

The invention relates to a boot program update and restoration system and method, and especially to a boot program update and restoration system and method used in a computer-based platform to update and restore the boot program by setting and checking a flag value.

2. Related Art

A basic input output system (abbreviated as BIOS) is an important program in the booting process of a computer-based platform. Whether the boot program of the BIOS can control the hardware of a computer-based platform and whether the boot program can be successfully executed are key factors of the booting process of the computer-based platform.

Due to the rapid advance of computer hardware, a computer-based platform has to frequently update the old BIOS to the latest version in order to best utilize the new hardware. In addition, a computer-based platform becomes unworkable due to some unexpected factors resulting from the damage of the boot program. The damage makes the computer-based platform unable to perform the booting process. As a result, the update and the restoration of boot programs are necessary in computer-based platforms.

The most intuitive way to update BIOS is to change the BIOS ROM stored the boot program. However, this approach costs more, and the update process is complicated. A common approach to restore the boot program is to store multiple boot programs in multiple ROMs, and restore the boot program by an electrical circuit.

However, these prior approaches spend more on the storage space for storing the boot programs. In addition, since the damage of the boot programs cannot always be detected immediately, the computer-based platforms must spend more time to detect the damage and waste users' time.

### SUMMARY OF THE INVENTION

In view of the abovementioned problems, the invention proposes a boot program update and restoration method and system by checking the stored flag values to detect the status of the boot programs. In booting processes, the normality of the flag values indicates that the boot programs are executed successfully. On the other hand, the abnormality of the flag values indicates that the boot programs are corrupted and should be restored in order to successfully perform the booting processes. When updating the boot programs, the computer-based platforms can show the status of the update by setting and resetting the flag values.

With the proposed method and system, a computer-based platform is able to actively detect the abnormality of the boot program and perform the restoration automatically without the users' instructions, thus saving users' time. In addition, the hardware cost is saved since the computer-based platform is able to perform the update and the restoration of the boot program without extra hardware.

The details of the proposed method and system are as follows.

### DETAILED DESCRIPTION OF THE INVENTION

The invention is a boot program update and restoration method and system that determines whether the boot programs are successfully updated and whether the restoration of the boot program is needed by the flag values stored in the computer-based platforms 10.

FIG. 1 shows the system architecture of the invention:

(1) The detection configuration unit 30, which is the kernel of the invention, has the following two functions:

(a) Activating the update of the boot program: According to the users' instructions, the detection configuration unit activates the update of the boot program by generating an update signal to the load unit 60. Then, the load unit 60 retrieves the new boot program from one of the external sources (including source A81, source B82, source N83, etc.) of the computer-based platform via the bus 70, and sends the new boot program to the programmable storage unit 50 to update the stored boot program. When the update is complete, the detection configuration unit 30 sends a setup signal containing the pre-determined flag value to the dynamic access memory unit 40.

In addition, the update signal is also sent to the dynamic access memory unit 40 to reset the flag value. The flag value is set after the update of the boot program is completed.

(b) Activating the restoration of the boot program: When the computer-based platform 10 executes the BIOS, the detection configuration unit automatically checks the status of the flag value stored in the dynamic access memory unit 40. After detecting an abnormality, the detection configuration unit generates a restoration signal to the load unit 60. Then, the load unit 60 retrieves a boot program from one external source 80 of the computer-based platform via the bus 70, and sends the retrieved boot program to the programmable storage unit 50 to restore the boot program. After the restoration is completed, the detection configuration unit 30 sends a setup signal to the dynamic access memory unit 40 to set the flag value, and re-executes the BIOS.

(2) The dynamic access memory unit 40 stores the flag value, and resets the flag value when receiving an update signal (or a setup signal), respectively. Generally speaking, the dynamic access memory unit is random access memory (abbreviated as RAM). A memory block of RAM is allocated to store the flag value, and the remaining memory blocks are used by the load unit 50 to load the boot program when the computer-based platform executes the BIOS.

A flag value equal to a pre-determined value showa that the status of the boot program is normal after update or restoration. Otherwise, it shows that the status of the boot program is abnormal.

(3) The programmable storage unit 50, also known as programmable read-only memory (abbreviated as PROM), stores the boot program of the computer-based platform 10. The boot program is usually a compressed image file. When executing the BIOS, the computer-based platform decompresses the image file and sends the decompressed program to the dynamic access memory unit 40.
The data stored in the programmable storage unit 50 can be read and written by ways of electrical charge illumination or ultraviolet light illumination to update or restore the boot program.

(4) The load unit 60 loads the boot program to be updated or restored from one source 80 via the bus 70 according to the received update or restoration signal, and updates or restores the loaded boot program into the programmable storage unit 50 by ways of electrical charge illumination or ultraviolet light illumination.

A source 80 can be a peripheral device (e.g., a hard disk drive, a CD-ROM drive, a flash drive, etc.) storing the boot program. It can also be a network (e.g., Internet, Intranet, etc.) or a system (e.g., PXE System, etc.) storing the boot program and connected to the computer platform.

The operation of the computer-based platform, the cooperation among the mentioned units and all data and signal transmission are performed by the processing unit 20. The details are well known and hence are omitted here.

FIG. 2 shows the control flow of the proposed boot program update process describing how the computer-based platform 10 controls the flag value and updates the boot program.

First, when receiving a users' instruction to update the boot program, the detection configuration unit 30 clears (Step 100) the flag value. Then, the load unit 60 retrieves a new boot program from one source via the bus 70 (Step 110). The system then checks whether the loading is successful and whether the boot program is undamaged (Step 120). If the boot program is successfully loaded into the programmable storage unit 50, the detection configuration unit 30 resets the flag value to a pre-determined value and terminates the update process (Step 130). Otherwise, if the update is aborted by some external factors (e.g., power failure or crash of the computer-based platform), the loading process (Step 110) is not finished. Since the update process is terminated without setting the flag value, the flag value is a random number different from the pre-determined value.

FIG. 3 shows the control flow of the proposed boot program restoration process. When the computer-based platform executes the BIOS, the detection configuration unit 30 reads the flag value (Step 200) and checks whether the flag value is equal to the pre-determined value (Step 210). If so, the computer-based platform continues to execute the BIOS (Step 240) to finish the restoration process. Otherwise, the boot program is corrupted and needs to be restored. Then, the load unit retrieves an undamaged boot program from a source 80. The system then checks whether the loading is successful (Step 230). If so, the method enters step 240 to execute the BIOS and finish the restoration process. Otherwise, it indicates that the selected source does not store the required boot program or the transmission channel between the selected source 80 and the computer-based platform is unreliable. In this case, the proposed method selects another source 80 and enters step 20 to redo the retrieval of the required boot program. The search for sources 80 is performed sequentially according to the configuration of the computer-based platform 10.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

### BRIEF DESCRIPTION OF THE DRAWINGS

FIG. 1 shows the architecture of the invention.

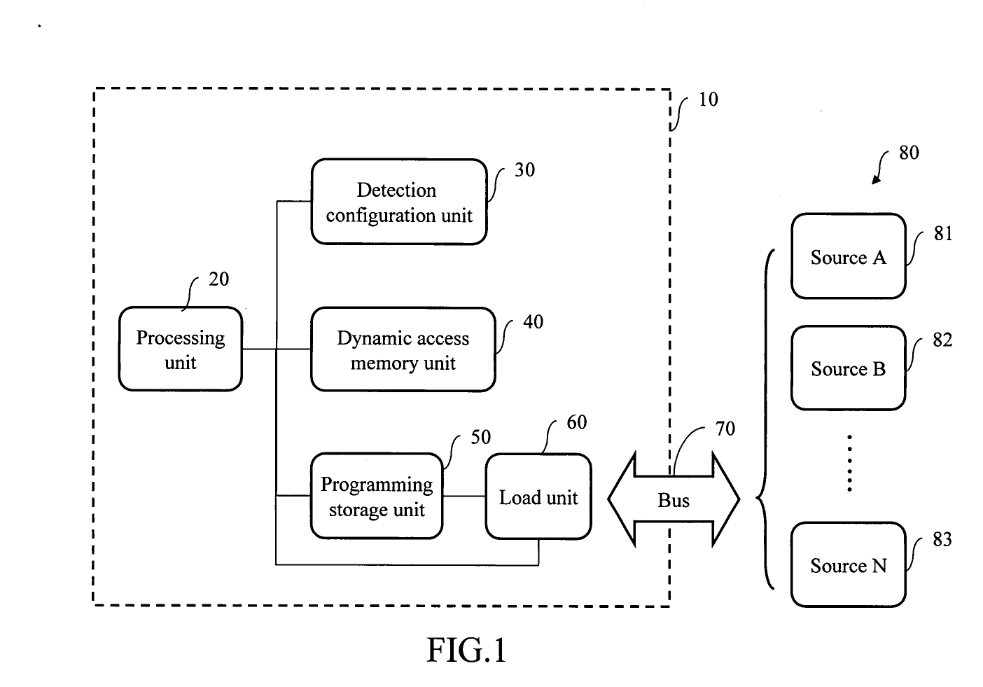

FIG. 2 shows the control flow of the proposed method of the invention.

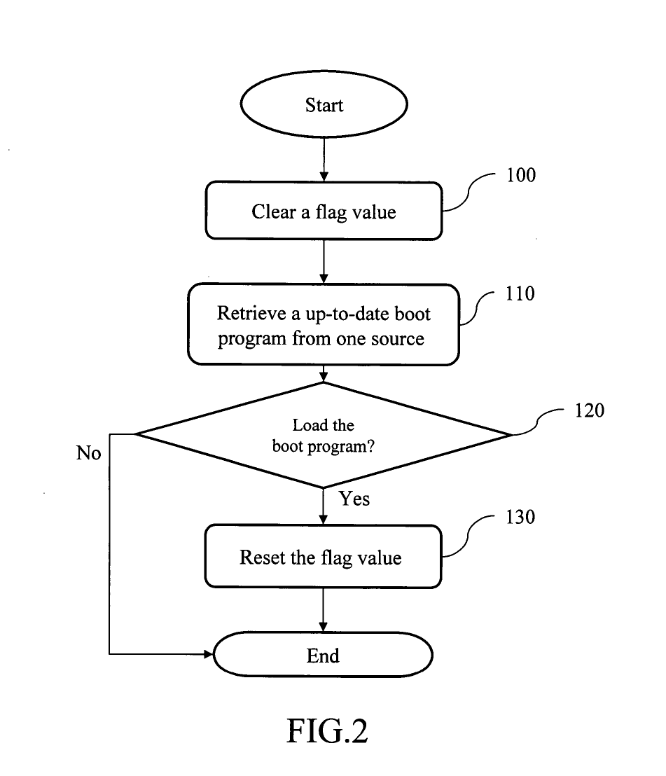

FIG. 3 shows the control flow of the proposed method of the invention.

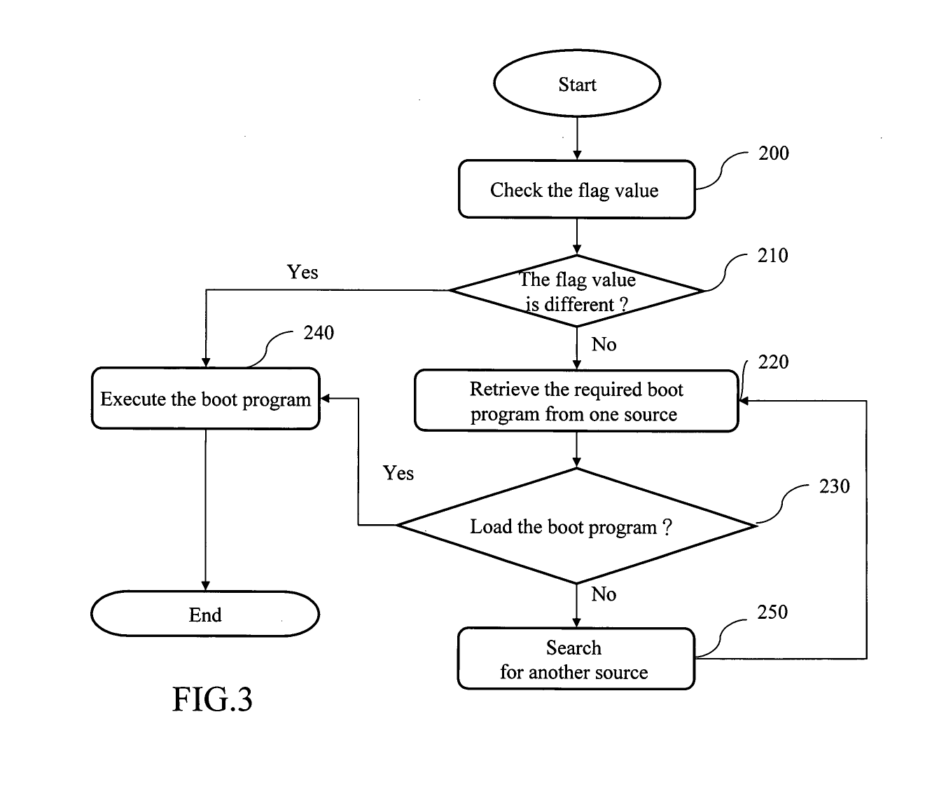

What is claimed is:

1. A boot program update and restoration system, comprising:
a programmable storage unit which stores a boot program of a computer-based platform;
a load unit which retrieves a boot program from a source according to an update signal or a restoration signal and stores the boot program in the programmable storage unit by a programming method;
a dynamic access memory unit storing a flag value, clearing the flag value in response to the update signal and setting the flag value after receiving a setup signal; and
a detection configuration unit which generates said update signal to update the boot program, generates said restoration signal to restore the boot program when the computer-based platform detects the abnormality of the flag value in the booting process, and generates said setup signal when the update or the restoration complete.

2. The system of claim 1, wherein the boot program is compressed image file.

3. The system of claim 1, wherein said source is selected from the group consisting of an external network, an external system and a peripheral device of the computer-based platform.

4. The system of claim 1, wherein said programming method can be electrical charge illumination or ultraviolet light illumination.

5. A boot program update and restoration method, which can update the boot program and set the flag value in a computer-based platform, comprising the following steps:
clearing the flag value;
retrieving an up-to-date boot program from a source; and
resetting the flag value.

6. The method of claim 5, wherein said source in retrieving step can be selected from the group consisting of an external network, an external system and a peripheral device of the computer-based platform.

7. A boot program update and restoration method, which can restore the boot program of a computer-based platform with abnormal flag value, comprising the following steps:
checking the flag value;
retrieving a copy of the boot program from a source when said flag value is differ than a pre-determined value; and
executing said boot program after restoration.

8. The method of claim 7, wherein the method further comprises the step to sequentially search other sources when the retrieving step fails.
